(19) United States
(12) Patent Application Publication
(10) Pub. No.: US 2018/0260658 A1
(43) Pub. Date: Sep. 13, 2018

(54) SYSTEMS AND METHODS FOR AVOIDING REDUNDANT PIXEL COMPUTATIONS IN AN IMAGE PROCESSING PIPELINE

(71) Applicant: QUALCOMM Incorporated, San Diego, CA (US)

(72) Inventors: Ajay Nawandhar, Bangalore (IN); Naveen Kumar Singh, Bangalore (IN); Joby Abraham, Bangalore (IN)

(21) Appl. No.: 15/454,926

(22) Filed: Mar. 9, 2017

(51) Int. Cl. G06K 9/62; H04N 5/345; G06T 1/20

(52) U.S. Cl. CPC G06K 9/6215; G06T 1/20; H04N 5/3456

(57) ABSTRACT

Systems and methods for processing pixels of an image at an imaging hardware device are provided. The method comprises receiving a first pixel. The method further comprises determining a content parameter of the first pixel. The method further comprises, based on the determining, storing the content parameter of the first pixel. The method further comprises initiating a computation of a first output pixel value for the first pixel. The method further comprises receiving a second pixel. The method further comprises determining a content parameter of the second pixel. The method further comprises determining that the second pixel is redundant in response to the content parameter of the second pixel matching the stored content parameter of the first pixel. The method further comprises, in response to the matching, setting a second output pixel value for the second pixel to be equal to the first output pixel value.

### BACKGROUND

### Field

The present application relates generally to image processing, and more specifically to systems, methods, and devices for avoiding redundant pixel computations in an image processing pipeline.

### Background

Today, video capture processes and hardware are being pushed to the edge with high-resolutions and high frame-rates in stand-alone imaging systems and cameras that are included on mobile devices, e.g., cell phones and tablets. While these advances improve user experience, they also present several challenges to device manufacturers, including increased power consumption. For example, as high-resolution sensors used in such imaging systems and devices continue to increase exponentially to 16 megabytes and above for both video and still-pictures, corresponding higher-end image processors are needed to effectively support the processing of the high through-put of such applications (e.g., via processing more image pixels per second or frames per second). This can cause the imaging systems performing this processing to generate an undesired level of heat, large power consumption, fast battery drain, and/or slow image processing rates.

Reducing voltage and/or frequency levels at an imaging device can reduce heat generation and increase battery power. However, given the finite amount of power available on a mobile device, improved methods and systems are needed that deliver the video resolution and frame rates allowed by modern hardware capabilities while ensuring these hardware capabilities do not adversely impact the user experience with regard to power consumption and/or device temperatures, and therefore, in some aspects, battery life and/or image processing speeds.

Images for processing at imaging devices contain a high amount of pixels, for example, millions of pixels. Consequently, there often exist high correlations among the image input pixels processed by imaging devices; and thus, redundant pixel computations often occur at such devices. Therefore, systems for taking advantage of correlating pixel information based on these and other correlations are desirable.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages that include improved communications between access points and stations in a wireless network. Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present application provides a method for processing pixels of an image at an imaging hardware device. The method comprises receiving a first pixel. The method further comprises determining a content parameter of the first pixel. The method further comprises, based on the determining, storing the content parameter of the first pixel. The method further comprises initiating a computation of a first output pixel value for the first pixel. The method further comprises receiving a second pixel. The method further comprises determining a content parameter of the second pixel. The method further comprises determining that the second pixel is redundant in response to the content parameter of the second pixel matching the stored content parameter of the first pixel. The method further comprises, in response to the matching, setting a second output pixel value for the second pixel to be equal to the first output pixel value.

Another aspect of the present application provides an apparatus for processing pixels of an image. The apparatus comprises a binning and compare unit configured to receive a first pixel. The binning and compare unit is further configured to determine a content parameter of the first pixel. The apparatus further comprises an input lookup table in connection with the binning and compare unit, wherein the input lookup table is configured to, based on the binning and compare unit determining the content parameter of the first pixel, store the content parameter of the first pixel. The apparatus further comprises an index generator configured to initiate, in connection with a first logic component, a computation of a first output pixel value for the first pixel. The binning and compare unit is further configured to receive a second pixel, determine a content parameter of the second pixel, and in connection with the input lookup table, determine that the second pixel is redundant in response to the content parameter of the second pixel matching the stored content parameter of the first pixel. The apparatus further comprises a logic circuit for establishing a data connection between the input lookup table and an output lookup table, wherein in response to the matching, the logic circuit is configured to facilitate, at a selection module in connection with the output lookup table, setting a second output pixel value for the second pixel to be equal to the first output pixel value.

Another aspect of the present application provides an apparatus for processing pixels of an image. The apparatus comprises means for receiving a first pixel. The means for receiving is further configured to determine a content parameter of the first pixel. The apparatus further comprises means for storing, based on the determining, the content parameter of the first pixel. The apparatus further comprises means for initiating a computation of a first output pixel value for the first pixel. The means for receiving is further configured to receive a second pixel, determine a content parameter of the second pixel, and determine that the second pixel is redundant in response to the content parameter of the second pixel matching the stored content parameter of the first pixel. The apparatus further comprises means for facilitating, in response to the matching, setting a second output pixel value for the second pixel to be equal to the first output pixel value.

Another aspect of the present application provides a non-transitory computer-readable medium comprising code that, when executed, causes an apparatus to perform a method. The method comprises receiving a first pixel. The method further comprises determining a content parameter of the first pixel. The method further comprises based on the determining, storing the content parameter of the first pixel. The method further comprises initiating a computation of a first output pixel value for the first pixel. The method further comprises receiving a second pixel. The method further comprises determining a content parameter of the second pixel. The method further comprises determining that the second pixel is redundant in response to the content parameter of the second pixel matching the stored content parameter of the first pixel. The method further comprises, in response to the matching, setting a second output pixel value for the second pixel to be equal to the first output pixel value.

### BRIEF DESCRIPTION OF THE DRAWINGS

FIG. 1 illustrates an imaging hardware system in which one or more aspects of the present disclosure can be employed.

FIG. 2 illustrates a functional block diagram for an image signal processing (ISP) bypass system that can be employed within the imaging hardware system of FIG. 1, in accordance with an exemplary embodiment.

FIG. 3 is a flowchart of an example method for reducing power consumption during image processing, in accordance with one or more aspects of an implementation.

### DETAILED DESCRIPTION

Various aspects of the novel systems, apparatuses, methods, and mediums are described more fully hereinafter with reference to the accompanying drawings. The teachings disclosed may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, methods, and mediums disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to, or other than, the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different imaging technologies and system configurations and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Images for processing at imaging devices can contain millions of pixels. Consequently, such images often include a high correlation among the image input pixels processed by the associated imaging device (e.g., a camera). Due to this, such imaging devices often incur several redundant pixel computations while processing a given image, which can waste power.

As an example, an imaging device (e.g., a camera) may generally include an ISP pipeline, which can includes any number of ISP blocks. Each of the ISP blocks may perform a particular function for processing an image for the imaging device. For example, one ISP block can filter pixels for the image, another ISP block can enhance the pixels, and another ISP block can smooth the pixels. Any number of other processes or adjustments for an image via one or more other ISP blocks can occur during an ISP pipeline, as will be understood by one having ordinary skill in the art.

During the image signal processing (ISP) pipeline, certain of the ISP blocks may incur higher input correlation among pixels than other of the ISP blocks. As one example, hardware accelerator blocks with particular kernel sizes (e.g., a kernel size of one) may experience high input correlation among pixels. Although power savings may be realized by implementing the aspects described herein in connection with any ISP block, certain of the aspects described herein may be advantageous for implementation on for example, camera blocks such as Linearization, Gamma Correction, Color correction, Skin color enhancement, 2dLUT (two-dimensional lookup table), GTM (Global Tone Mapping), AWB (auto white balance), Color transform, Chroma Enhancement, Chroma Suppression, etc. Furthermore, particular types of images may results in higher correlation than other types of images. For example, images that include large areas of like-colors (e.g., spatial correlation) may cause an ISP processing such images to incur high rates of input correlation among the pixels. Furthermore, as resolutions increase (e.g., the number of pixels), so too may the rate of input correlation among pixels increase, due to temporal correlations, as one example.

Some imaging systems attempt to alleviate these issues by “dropping” (e.g., not processing) certain of the high correlation pixels via software algorithms and/or via various hardware components operatively coupled to one or more of the ISP blocks of the systems. For example, an imaging system may utilize aspects of a processor, central processing unit (CPU), memory, graphics processing unit (GPU), or any number of other hardware aspects in conjunction with software to remove certain pixels. As another example, image capture devices, such as smart phone cameras, often include a system-on-a-chip (SOC), which can include a number of onboard ISPs. For instance, one or more ISPs can be included on the SOC to help the camera meet frame rate and resolution requirements.

ISPs can be software-based, hardware-based, or both, and typically utilize an imaging processing pipeline (which may also be referred to herein as an “image signal processing pipeline,” an “ISP pipeline,” or an “imaging pipeline”), which can include a number of ISP processing blocks (e.g., camera accelerator blocks). Hardware-based ISPs often include fixed imaging processing pipeline architectures, such as for linearized station hardware blocks, color transform hardware blocks, chroma enhancement hardware blocks, etc. All of the hardware blocks of the ISP work together to accept incoming pixels, process the pixels (e.g., identify and predict pixel patterns), and then convert and output processed image data (e.g., YUV data) for further system processing or display.

When hardware-based ISPs compute input pixels for an image, power is consumed at the device. The more pixels that the ISP processes, the more power will generally be consumed. As described above, often times, hardware-based ISPs are forced to compute redundant pixels, for example, when there is correlation among input pixels, as is frequently the case. Such redundant computations unnecessarily consume power for the device, which reduces battery life, lengthens computation time, and increases heat.

Software-based ISPs can partially address redundant pixel issues by utilizing various techniques. One such technique, convolution, is an image content-based procedure that involves identifying and “dropping” pixels that are not in a region of interest. In this way, the software-based ISP will only process a portion of the incoming pixels. Unfortunately, although this can reduce computation time, and to some extent, computation power, such a system removes pixels from the image, which causes the outputted image to have less pixels than the inputted image (e.g., reduced resolution). Furthermore, utilizing a software-based ISP typically requires the use of a graphics processing unit (GPU), among other components, which increases costs, programming complexity, as well as power usage. Thus, hardware-based ISPs are often preferred over software-based ISPs.

Even still, because hardware-based ISPs generally include fixed processing pipelines in which every pixel input is processed (e.g., according to a kernel size), traditional hardware-based ISPs have not been configured to implement image content-based power-saving techniques. That is, despite their other performance benefits over software-based ISPs, traditional hardware-based ISPs have not been configured to dynamically “drop” pixels from the computation line (e.g., “inline” or “in real-time”), based on image content, or otherwise.

Thus, aspects of the embodiments described herein are generally directed to a hardware-based real-time logic system for bypassing computations of an image signal processor (ISP). In an aspect, the aspects described herein may be integrated on a digital circuit and be configured to bypass computations of certain correlating pixel categories (e.g., color categories based on identified spatial correlations). More specifically, the aspects may include a number of logical stages, implanted via digital circuitry within an imaging hardware system. Spatial correlations (or “spatial localities”) can be based on types of input content of pixels and/or pixel packing structures, among other content types. As one example, for a Bayer image input, spatial locality may be two (e.g., every alternate pixel is of the same channel and has a higher match probability). Thus, as will be further described below, the use of two (or more) lookup tables (LUTs) in connection with the systems and aspects described herein may be advantageous.

Furthermore, aspects that take advantage of temporal correlations (e.g., time-based correlations based on a preserved pixel history of N samples in any given computing direction) among pixels may also be utilized for enabling the aspects described herein. In general, temporal correlations (or “temporal localities”) may be determined by a LUT depth kept to store pixels. As further described below, an increased LUT depth may increase a bypass rate for incoming pixels, thereby lowering overall power consumption for the associated imaging device.

The systems and methods described herein may be implemented on an imaging hardware system and function entirely without the use of various components of the imaging hardware system, e.g., processor, central processing unit (CPU), memory, graphics processing unit (GPU), or any number of other hardware and/or software aspects of the imaging hardware system. The aspects may be implemented in real-time, as further described below. One advantage provided by the systems described herein may be allowing an imaging hardware system to achieve very low dynamic power by predicting and dropping redundant pixel computes in any hardware block having, for example, a fixed pipelined architecture. As further described below, a pixel prediction technique in accordance with an embodiment can include a hybrid approach of spatial and temporal correlations, based on which a hardware block (e.g., an ISP block) may be fully bypassed. Furthermore, pixel predictions of the systems described herein may allow for predicting output pixels early in an imaging pipeline, which can enable the power saving benefits to flow through to the remainder of the imaging pipeline. For example, the power savings can be directly proportional to the number of pixel computes dropped during the pipeline.

As a non-limiting example of a portion of the beneficial aspects described herein, the ISP bypass system described in further detail below may bin and categorize an incoming pixel according to its spatial-content, which may be referred to herein as determining a content parameter of the pixel. That is, a binning and compare unit may analyze the incoming pixels and group them into categories. For example, the device can bin incoming pixels into categories (e.g., based on spatial locality) and assign a lookup (LUT) table (e.g., an “input LUT”) for each of the categories. The binning and compare unit may then compare the content parameter for the pixel with spatial content (e.g., content parameters) of previous pixels previously stored at the input lookup table. If no match is found (a “miss” case), the system may store the content parameter for the pixel at the input LUT and proceed to initiate a computation of the pixel at the associated ISP.

Thereafter, the system may bypass computations for subsequent incoming pixels that match the information stored at the input lookup table (i.e., “redundant pixels”) by outputting the matching cached information at the output lookup table. For example, if a subsequently inputted pixel is determined to have a match at the input LUT (e.g., a “hit” case), as further described below, then the ISP bypass system can be considered as having determined that the pixel is redundant and may thus cause computations for the pixel to be bypassed (e.g., by an associated ISP block) and/or halt computations and clock cycles for the pixel (“drop the clock” or “drop the pixel”) with respect to the incoming pixel.

Continuing with this non-limiting example, the system may, in either a hit or miss case, determine index information for the current pixel (e.g., via an index generator), which may be queued in a latency FIFO unit of the system for a particular number of clock cycles. In connection with this, and as further described below, the ISP bypass system may then wait a number of clock cycles according to aspects of a latency FIFO unit. The latency FIFO unit may act as a channel (e.g., or as a LUT pipeline, as part of a LUT pipeline, and/or as part of a logic circuit) from the input LUT to an output LUT (discussed below) and can enable the device to maintain proper pixel processing timing, for example, to account for dropped clock cycles caused by bypassing computations for the pixel. In other words, the input LUT, output LUT, and output-based multiplexer of the system, which are further described below, are connected (or “tied”) via certain pixel parameters (e.g., an LUT ID value, an LUT index value, and/or hit and miss information), such that said computed output data stored at the output LUT may match the above discussed generated index value for the same pixel category and maintain timing integrity for the device. As described herein, the LUT pipeline may also be referred to generally as a logic circuit. The logic circuit can be for establishing a data connection between the input LUT and the output LUT, as further described below.

Continuing with this non-limiting example, after waiting some number of clock cycles based on the latency FIFO, the device can identify matching cached output data previously stored in a outlook LUT and then send a copy of the cached data to the output-based multiplexer. Put another way, after the wait, a parameter of the pixel (e.g., the pixel matched during the “hit” case) can be matched to a cached parameter of a previously computed pixel (the one that did not match during the “miss” case). The located cached data can then be output from the imaging hardware device. In this way, the device may effectively “process” the pixel associated with the “hit” case in preparation for outputting the pixel value, without the need for “computing” the pixel. Furthermore, the system may be configured to perform such aspects without reducing resolution or quality of the image, because the number of inputted pixels is configured to be equal to the number of outputted pixels according to the below described methods. In this way, having caused every inputted pixel to reach the output from either the computation module (e.g., the associated ISP block) or the cached output data LUT in association with the bypass system, the device will have effectively processed each pixel (i.e., via its fixed processing pipeline) while avoiding performing intensive calculations for some portion of the pixels (i.e., having “dropped” those portions), which can save power.

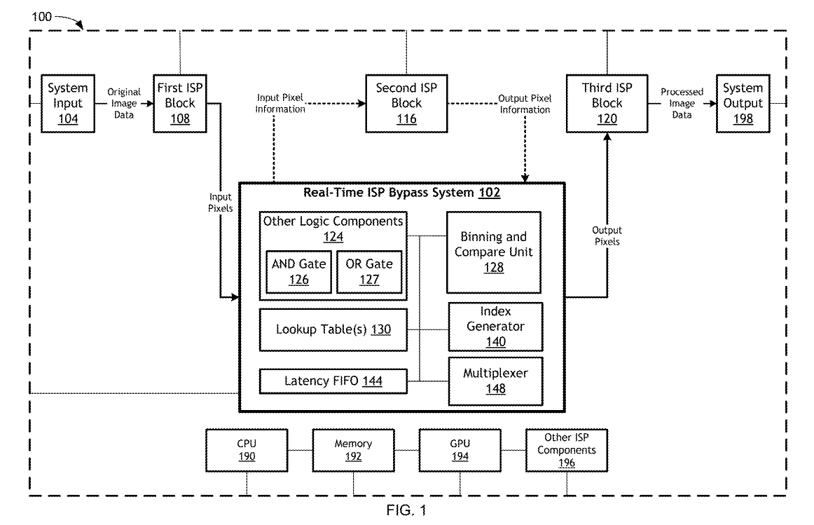

FIG. 1 illustrates an imaging hardware system 100 in which one or more aspects of the present disclosure can be employed. For example, the imaging hardware system 100 can comprise a digital camera. The imaging hardware system 100 can include a bussing system (represented by a rectangular dashed line) for interconnecting one or more internal components of the imaging hardware system 100. As illustrated (e.g., via components including a line to the dashed line), any one of the components in the imaging hardware system 100 may then be effectively connected for communications with any or all of the other components included in the imaging hardware system 100. The ISP bypass system 102 can include any number of components configured to perform, alone or in combination with one another, the various functionalities of the ISP bypass system 102. Some or all of the components and/or the imaging hardware system 100 can be electrically coupled to and/or communicate with one another, for example, via the bussing system, which may include a data bus, for example, as well as a power bus, a control signal bus, and a status signal bus in addition to the data bus. One or more components of the imaging hardware system 100 may be described herein as “in connection with” one another, which can indicate that the components are, for example, coupled. As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. Those of skill in the art will appreciate that various components of the ISP bypass system 102 and/or the imaging hardware system 100 may be coupled together or accept or provide inputs to each other using some other mechanism.

As described above, the imaging hardware system 100 can include a number of ISP blocks. In the illustrated example, the imaging hardware system 100 includes three ISP blocks (e.g., a first ISP block 108, a second ISP block 116, and a third ISP block 120). In other embodiments, the imaging hardware system 100 can include less or more ISP blocks than that illustrated. In any case, the “computation line” from the first ISP block 108 until the final ISP block (e.g., the third ISP block 120) may generally be referred to as the ISP pipeline for the imaging hardware system 100. One or more of the first ISP block 108, the second ISP block 116, and/or the third ISP block 120 may comprise any number of hardware and/or software components, data pathways, logic gates and systems (e.g., including flipflops and the like). Furthermore, although each of the first ISP block 108, the second ISP block 116, and the third ISP block 120 are illustrated and referred to herein as single blocks, any or all of the first ISP block 108, the second ISP block 116, and the third ISP block 120 may comprise a set of ISP blocks (not pictured), e.g., in a back-to-back configuration. Thus, in an aspect, the imaging hardware system 100 may include any total number of ISP blocks. As described herein, the ISP blocks included in the imaging hardware system 100 may generally be referred to as “the ISP blocks” and/or “the ISPs.”

Furthermore, the imaging hardware system 100 may also include a system input 104 for inputting image information (e.g., a sensor capturing image data) to be sent as original image data to begin processing at the first ISP block 108. The pixels may traditionally travel through the entirety of the ISP pipeline and be output as processed image data, for example, to a system output 198 (e.g., a bitstream).

In addition, the imaging hardware system 100 may further comprise one or more additional hardware components for processing image data alone, or in combination with, one or more of the system input 104, the first ISP block 108, the second ISP block 116, the third ISP block 120, and/or the system output 198. For example, the imaging hardware system 100 may include a central processing unit, which may be referred to herein as the CPU 190. The imaging hardware system 100 may further include a memory 192, a graphics processing unit (referred to herein as the GPU 194), and/or any number of a set of other ISP components 196.

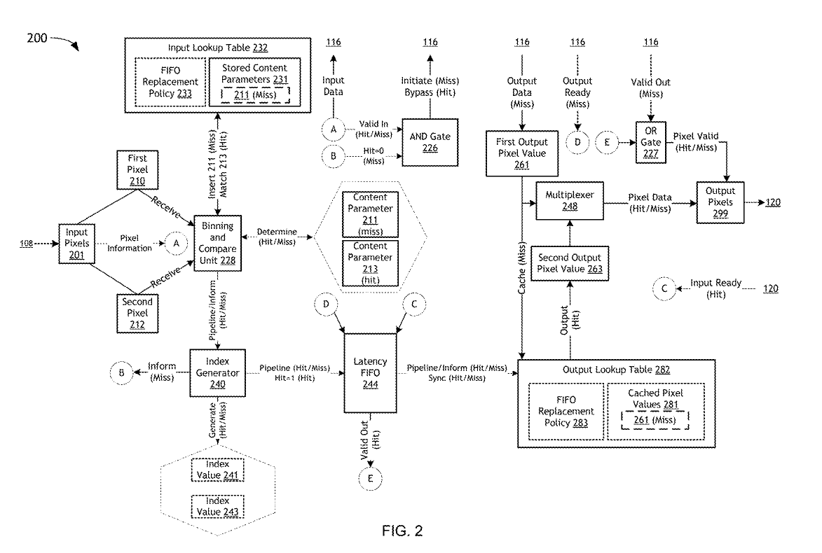

So as to enable the power saving benefits described herein, an ISP bypass system 102 may be implemented on the imaging hardware system 100 in accordance with an exemplary embodiment. As further described below in connection with FIG. 2, the ISP bypass system 102 may comprise a binning and compare unit 128, a set of lookup tables 130, an index generator 140, a latency FIFO unit 144, a multiplexer 148, a set of other logic components 124, etc. The set of other logic components 124 may comprise, for example, an AND gate 126, an OR gate 127, or any number or combination of digital logic-based logic components. In one aspect, the index generator 140 may generate index values for the lookup tables in accordance with embodiments described herein. In an aspect, the multiplexer 148 may also be referred to herein as a “selection module.”

In another aspect, the latency FIFO unit 144 may reduce and/or eliminate system back pressures by communicating with one or both of the second ISP block 116 and the third ISP block 120 regarding when such devices and the latency FIFO unit 144 are ready for output and/or input of communications. In an embodiment, a depth of the latency FIFO unit 144 may be greater than or equal to a number of pipeline stages at the second ISP block 116. This may enable the latency FIFO unit 144 to initiate computations of a pixel falling under a “miss” case and/or to initiate bypassing computations of a pixel falling under a “hit” case, as further described below. As one example, the latency FIFO unit 144 may gate a valid to the OR gate 127. In an aspect, the latency FIFO unit 144 can store various identifiers for corresponding pixels, for example, a LUT identifier (e.g., LUT_id), a LUT index value (e.g., LUT_index), and/or hit-and-miss information (e.g., hit=0 and/or hit=1). In one example, such identifiers may be derived at the input lookup table 232 in connection with the binning and compare unit 228, the index generator 240, and the binning and compare unit 228, respectively.

In general, the ISP bypass system 102 may function in real-time to dynamically identify redundant pixels input from the first ISP block 108. In a traditional imaging hardware system 100, such redundant pixels may each be processed by the second ISP block 116. However, as described herein, the ISP bypass system 102 can enable bypassing computations of such redundant pixels. Furthermore, even though computations for redundant pixels are avoided, the ISP bypass system 102 may still output a number of output pixels that is equal to a number of input pixels to the ISP bypass system 102, as further described below in connection with FIG. 2.

Although illustrated in connection with one or more ISP blocks (e.g., the first ISP block 108, the second ISP block 116, the third ISP block 120, etc.), the ISP bypass system 102 should not be considered as a component or part of any of said ISP blocks. Instead, the ISP bypass system 102 can be implemented to bypass computations of one or more pixels (e.g., pixels that the ISP bypass system 102 identifies as redundant) at one or more of the ISP blocks during the ISP pipeline, as will be further described below in connection with FIG. 2. In a scenario in which the second ISP block 116 comprises multiple ISP blocks in a back-to-back configuration (not pictured), the systems described herein may be extended to be properly implemented therein, as further described below.

Once the ISP bypass system 102 is ready to output the computed pixels and the pixels that bypassed computations (e.g., the sum of which will equal the number of pixels input to the ISP bypass system 102, as further described below), the ISP bypass system 102 may output (e.g., transmit) the pixels to the third ISP block 120 for further processing. As one having ordinary skill in the art will understand, the first ISP block 108, the second ISP block 116, and/or the third ISP block 120 may communicate with one another by sending signals to one another. As one example, traditionally, the third ISP block 120 may send a ready for input signal (e.g., an in_rdy signal) to the second ISP block 116 when the third ISP block 120 is ready to receive input pixels. Similarly, traditionally, the second ISP block 116 may send a ready for output signal (e.g., an out_rdy signal) to the third ISP block 120 when the second ISP block 116 is ready to transmit output pixels.

Furthermore, the ISPs may communicate certain information to one another about the pixels being processed. For example, the ISPs may communicate a validity parameter for each pixel. For example, if one of the ISPs determines that data related to one or more pixels is unreliable, the ISP may set the validity parameter for the corresponding pixel to be equal to zero (e.g., valid=0). In an aspect, if an ISP (e.g., the second ISP block 116) receives a pixel including a validity parameter of valid=0, the second ISP block 116 will understand that pixel as unreliable and will not process the pixel. Instead, in one aspect, the pixel may the second ISP block 116 may transmit (or “pass”) the data for the corresponding pixel as “stuffing symbols,” which may be all zeroes, all black pixels, or the like. In an aspect, the second ISP block 116 (or any other ISP) may only perform computations for any given pixel when the pixel is accountable, for example, when valid=1. As one having ordinary skill in the art will understand, although the second ISP block 116 (or any other ISP) may not use processing resources for explicitly computing the data for an unreliable pixel, the second ISP block 116 (or any other ISP) may still pass the pixel to the next ISP in the pipeline (e.g., the third ISP block 120), so as to maintain the order and identity of the pixels in the pixel computation line.

In accordance with the non-limiting example described above, in general, the binning and compare unit 128 included in the ISP bypass system 102 may be a part of an input stage for binning incoming pixels based on spatial locality, for example, to increase a hit ratio, as further described below. For example, the binning and compare unit 128 can categorize incoming pixels and direct them to respective lookup table blocks (e.g., one of the set of lookup tables 130). The binning and compare unit 128 can therefore utilize input content spatial locality information for binning pixels to their respective one of the set of lookup tables 130. In one example, the binning and compare unit 128 may compare parameters of an incoming pixel across particular contents stored at an input LUT (e.g., according to a FIFO temporal correlation manner). Based on the comparison, for example, if the binning and compare unit 128 determines that the current pixel does not match (“misses”) a cached pixel (e.g., at the input LUT), then the ISP bypass system 102 can insert the pixel value into the input LUT (e.g., according to a FIFO replacement policy) and then send the pixel to an associated computation module (e.g., the second ISP block 116) for processing. The input lookup table (e.g., one of the set of lookup tables 130) may therefore comprise a temporal prediction engine that can take identify and take advantage of temporal correlations by enabling the ISP bypass system 102 to bypass, or skip, a number of recently computed pixels based on the determinations (e.g., identifying redundant pixels, as further described below).

A data path (e.g., pipeline) of the ISP bypass system 102 may include a gating unit (e.g., the AND gate 126) in connection with the latency FIFO unit 144, which may operate to maintain the processing timing for the pixel line. In an aspect, a pipeline latency for the input pixels may be predetermined.

At the output stage for the ISP bypass system 102, the ISP bypass system 102 may include an output lookup table (e.g., another of the set of lookup tables 130) in connection with the multiplexer 148 for outputting pixels to the third ISP block 120. For example, the output lookup table may receive a computed pixel output value from the computation module (e.g., the second ISP block 116) and store the value in a cache of the output LUT. A copy of the computed pixel output value may be stored (e.g., cached) at the output LUT in a similar FIFO temporal correlation manner as that of the input LUT. The computed pixel information (e.g., for the “miss” case pixel) can also be output from the imaging hardware device at this time. In an aspect, as the possibility for temporal pixel redundancy increases, the ISP bypass system 102 may be configured to include LUT tables of higher depth, enabling analysis of greater pixel areas. In contrast, if temporal pixel redundancy is low in a pixel block area, the ISP bypass system 102 may be configured to comprise lookup tables having lower depths.

An exemplary embodiment example for bypassing computations at a ISP bypass system similar to that of the ISP bypass system 102 is described in connection with FIG. 2 below.

FIG. 2 illustrates a functional block diagram for an image signal processing (ISP) bypass system 200 that can be employed within an imaging hardware system (e.g., the imaging hardware system 100 described in connection with FIG. 1), in accordance with an exemplary embodiment. The ISP bypass system 200 is an example of a system that can be configured to implement the various methods described herein. With respect to the description of FIG. 2 herein, some of the item numbers may refer to the so-numbered aspects described above in connection with FIG. 1. For example, the first ISP block 108, the ISP bypass system 200, an AND gate 226, an OR gate 227, an input lookup table 232, a latency FIFO unit 244, a binning and compare unit 228, an index generator 240, a multiplexer 248, the second ISP block 116, an output lookup table 282, and the third ISP block 120, may comprise, respectively, the first ISP block 108, the ISP bypass system 102, the AND gate 126, the OR gate 127, the input LUT described in connection with the set of lookup tables 130, the latency FIFO unit 144, the binning and compare unit 128, the index generator 140, the multiplexer 148, the second ISP block 116, the output LUT described in connection with the set of lookup tables 130, and the multiplexer 148, all described in connection with FIG. 1 and the immediately preceding paragraphs. The AND gate 226 may also be referred to herein as a first logic component. The OR gate 227 may also be referred to herein as a second logic component. The latency FIFO unit 244 may also be referred to herein as a latency timing unit.

The first ISP block 108, the second ISP block 116, the third ISP block 120, the set of other ISP components 196, or any other ISP block or component (not pictured) of the imaging hardware system 100 may utilize various software and/or the set of other ISP components 196. In view of the descriptions above, it should be understood, however, that the ISP bypass system 200 may perform the described operations without utilizing the CPU 190, the memory 192, the GPU 194, or any the set of other ISP components 196, for example. That is, the as described herein may be performed by the ISP bypass system 200 may be performed dynamically (or “in real-time” or “on-the-fly”).

Furthermore, the ISP bypass system 200 may also include a total number of input pixels 201, a first pixel 210, a second pixel 212, a content parameter 211, a content parameter 213, an index value 241, an index value 243, a set of stored content parameters 231, a FIFO replacement policy 233, a first output pixel value 261, a FIFO replacement policy 283, a set of cached pixel values 281, a second output pixel value 263, and a total number of output pixels 299. Such aspects may generally comprise the corresponding aspects described above in connection with FIG. 1 and the immediately preceding paragraphs, and as further described below.

As illustrated, the ISP bypass system 200 may be in connection with the first ISP block 108, the second ISP block 116, and the third ISP block 120, similar to the layout as illustrated in FIG. 1. Thus, the ISP bypass system 200 may receive the total number of input pixels 201 from the first ISP block 108. In regular processing course, pixel information for each of the pixels of the total number of input pixels 201 may be sent to the second ISP block 116, for example, as illustrated by item A. Pixel information may include, for example, input data and/or input validity information (e.g., valid_in) for each pixel, as described above.

The total number of input pixels 201 may include the first pixel 210 and the second pixel 212, each of which may be received by the binning and compare unit 228. First in time in this example, the binning and compare unit 228 may receive the first pixel 210. In accordance with the descriptions above, the binning and compare unit 228 may then determine the content parameter 211 for the first pixel 210, and, in connection with the input lookup table 232, determine whether the first pixel 210 is redundant. For example, in connection with the input lookup table 232, the binning and compare unit 228 may determine that the content parameter 211 is not a redundant pixel, because there may not be any content parameters stored in a set of stored content parameters 231 at the input lookup table 232. Thus, in accordance with an embodiment, the content parameter 211 (e.g., in association with the first pixel 210) may be considered as a “miss” case, as described above. Thus, as illustrated, the input lookup table 232 may store the content parameter 211 at the set of stored content parameters 231. In an embodiment, the input lookup table 232 may store content parameters (e.g., the content parameter 211) at the set of stored content parameters 231 in accordance with a (first-in-first-out) FIFO replacement policy 233.

As an example, the content parameter 211 in association with the first pixel 210 may comprise a content category (e.g., being part of a particular color category). Thus, the first pixel 210 can be categorized according to its content-based parameters determined by the binning and compare unit 228 as the content parameter 211. In an aspect, the content parameter 211 may also be referred to as a “content identifier” or a “content ID,” among other similar references.

In an aspect, the input lookup table 232 can store (or “insert”) the content parameter 211 in the set of stored content parameters 231, as illustrated, based on the determination by the binning and compare unit 228 that the content parameter 211 is associated with a “miss” case. In this way, the input lookup table 232 may store the content parameter 211 in connection with a temporal correlation via the FIFO replacement policy 233. As described herein, the input lookup table 232 may also be referred to as an “input pixel LUT.”

The input lookup table 232 can generally be in connection with any of the set of lookup tables 130, for example, via a logic circuit for establishing a data connection between the input LUT and the output LUT. Such logic circuit and/or data connection may also be referred to herein as a lookup table pipeline or an “LUT pipeline.” As an example with reference to FIG. 2, the input lookup table 232 can be in data connection with the output lookup table 282 via a logic circuit that establishes a data pipe line or LUT pipeline (not explicitly pictured) between the input lookup table 232 and the output lookup table 282. The logic circuit can comprise one or more of the components illustrated in FIG. 2, and/or any number of components not illustrated in FIG. 2 appropriate for establishing a data connection between the input lookup table 232 and the output lookup table 282. That is, for example, the input lookup table 232 may communicate data to the binning and compare unit 228, and the binning and compare unit 228 may then send such data to the index generator 240. As described herein, the logic circuit (or “LUT pipeline”) may establish a data connection between the input lookup table 232 and the output lookup table 282 via one or more of the binning and compare unit 228, the index generator 240, the AND gate 226 (e.g., a first logic component), the latency FIFO unit 244 (e.g., a latency timing unit), the OR gate 227 (e.g., a second logic component), and/or the multiplexer 248 (e.g., a selection module). In some examples, the logic circuit may also be described herein as including one or both of the input lookup table 232 and the output lookup table 282.

As one example with reference to the ISP bypass system 200, the index generator 240 can receive information from the binning and compare unit 228 (e.g., the content parameter 211) with an associated indication of whether the content parameter 211 was a hit case or a miss case (a “miss,” in this example). In a miss case, the index generator 240 may send a miss indication to the AND gate 226 (e.g., hit=0), in addition to sending other signals, as described below. And when the AND gate 226 receives the miss indication, the AND gate 226 may then proceed to initiate computation of a first output pixel value 261 (e.g., by the second ISP block 116). That is, in the “miss” case, via at least the index generator 240 and the AND gate 226, the ISP bypass system 200 may initiate a computation for the first pixel 210. For example, the ISP bypass system 200 may initiate the second ISP block 116 to compute the first output pixel value 261. Due to the nature of the AND gate 226, the AND gate 226 may receive a valid_in signal via item A and also the hit=0 signal via item B (from the index generator 240) in the “miss” case. This may cause the AND gate 226 to initiate the computation at the second ISP block 116 by sending the valid=1 for the associated pixel (e.g., the first pixel 210) to the second ISP block 116. As described above, in the normal course of ISP operation, the second ISP block 116 may then proceed to process the first pixel 210 as a valid pixel, having received both input data and a valid in for the first pixel 210.

In contrast, in a hit case, for example, when the AND gate does not receive hit=0 from the index generator 240 (or, for example, if the AND gate 226 receives a hit=1) from the index generator 240, the AND gate 226 will not initiate a computation at the second ISP block 116. Instead, for the pixel that “hit” (e.g., a redundant pixel, the content parameter 213 in this example), the AND gate 226 can, for example, send a valid=0 to the second ISP block 116, which indicates to the second ISP block 116 that the reliability of the second pixel 212 is not high enough for processing, which can cause the second ISP block 116 to not process (e.g., bypass computations for) the second pixel 212, saving resources, as described above in connection with FIG. 1 and the preceding paragraphs. Nonetheless, in the hit case, so as not to reduce image resolution, the ISP bypass system 200 can be configured to maintain processing timing via the latency FIFO unit 244, as further described below.

As described above, a “hit” case occurs when the binning and compare unit 228 determines that the pixel at issue (e.g., the second pixel 212) is redundant. The binning and compare unit 228 does this in connection with the input lookup table 232 and the set of stored content parameters 231 (e.g., the content parameter 211 in this example) by determining the content parameter 213 for the second pixel 212, and then determining that the content parameter 213 matches with the content parameter 211 that was previously stored at the content parameter 211. Having determined that the content parameter 213 is redundant (the “hit” case), then the binning and compare unit 228 sends the index generator 240 the “hit” case indication discussed above. In response, the index generator 240 can transmit this information to the latency FIFO unit 244, to be transmitted (e.g., after a certain number of clock cycles) to the output lookup table 282, such that the FIFO replacement policy 283 at the output lookup table 282 may be in sync with the FIFO replacement policy 283, as described in further detail below.

As an example, in the hit case, the latency FIFO unit 244 can instead initiate a read, and wait a number of clock cycles before allowing the output lookup table 282 to set the second output pixel value 263 equal to the first output pixel value 261. That is, to maintain the proper timing, the latency FIFO unit 244 can determine to wait a number of clock cycles in accordance with an out_vld received from the second ISP block 116. As described above, even when computations are bypassed at the second ISP block 116, in normal course, the second ISP block can process validity data in-time with the pixel line, which the latency FIFO unit 244 can utilize to maintain proper timing (e.g., another temporal correlation). In an aspect, the latency FIFO unit 244 can further wait for in_rdy from, for example, the third ISP block 120, before initiating reading from the first output pixel value 261 and allowing the output lookup table 282 to set the second output pixel value 263 as equal to the first output pixel value 261. The number of clock cycles can be based on the temporal correlation discussed above and in connection with the FIFO replacement policy 233 and the LUT pipeline. In an aspect, in either the hit or miss case, the latency FIFO unit 244 can send the output lookup table 282 the hit or miss information, in addition to sending the index value 241 and the content parameter 211 (e.g., during processing of the first pixel 210) and the index value 243 and the content parameter 213 (e.g., during processing of the second pixel 212), so as to always preserve the LUT pipeline temporal and spatial correlations described herein.

In an embodiment, the set of stored content parameters 231 may be stored at the input lookup table 232 based on the binning and compare unit 228 determining the hit or miss parameters, because the content parameters are stored (or not) according to a comparison performed by the binning and compare unit 228 to determine whether the determined parameters (e.g., the content parameter 211 and/or the content parameter 213) match any of the stored parameters (e.g., the content parameter 211 and/or the set of stored content parameters 231). In short, in the illustrated example, the content parameter 211 for the first pixel 210 is stored at the input lookup table 232, because the binning and compare unit 228 determines that the content parameter 211 does not match with any of the set of stored content parameters 231 (“miss” case). Then, the content parameter 213 for the second pixel 212 is not stored in the input lookup table 232, because the binning and compare unit 228 determines that the content parameter 213 matches with the content parameter 211 stored at the input lookup table 232 (e.g., “hit” case).

Continuing with the illustrated example, in either of a “hit” or a “miss” case, the index generator 240 may generate index values (e.g., the index value 241 for the first pixel 210) in association with content parameters (e.g., the content parameter 211) and the LUT pipeline described above. Then various other components (e.g., the latency FIFO unit 244, the output lookup table 282, etc.) may utilize the index values to consistently refer to particular content parameters (e.g., one or both of the content parameter 211 and the content parameter 213) when communicating among one another (e.g., via the LUT pipeline). Furthermore, in either of a hit or miss case, the index generator 240 may send LUT index and content parameters (e.g., the content parameter 211) to the latency FIFO unit 244.

In an aspect, the latency FIFO unit 244 can read or write to the system from the latency FIFO unit 244, depending on whether the current pixel is a hit or a miss. As illustrated via item D, in the miss case, the latency FIFO unit 244 can wait for out_rdy from the second ISP block 116, rather than waiting some number of clock cycles. In this scenario, the latency FIFO unit 244 may then initiate a write when the second ISP block 116 sends the out_rdy. In an embodiment, the latency FIFO unit 244 may only proceed in this way if the latency FIFO unit 244 also received a in_vld for the associated pixel, for example, similar to at Item A (e.g., the input stage for the pixel). In this example, after initiating the second ISP block 116 to compute the first output pixel value 261 for the “miss” case, the ISP bypass system 200 may receive output pixel information (e.g., the first output pixel value 261) from the second ISP block 116, when the second ISP block 116 has finished processing. Thus, to maintain processing timing and integrity, the latency FIFO unit 244 can be configured to wait to receive out_rdy from the second ISP block 116 (e.g., via item D) and, for example, an in_vld (as described above). Thereafter, as described above, the latency FIFO unit 244 can continue with the LUT pipeline by providing the pipeline information described above so as to sync, for example, the input lookup table 232 and the output lookup table 282 according to one or both of temporal and spatial correlations, as further described below.

That is, in an aspect, the output lookup table 282 can receive the first output pixel value 261 (e.g., in association with the first pixel 210) from the second ISP block 116 in the miss case. In this case, the computed output data (e.g., the first output pixel value 261) can be stored (or “cached”) among at the set of cached pixel values 281 at the output lookup table 282. In an aspect, the first output pixel value 261 may be the first value to be stored at the output lookup table 282, thus first initiating the generation of a container (not pictured) for the set of cached pixel values 281, including the first output pixel value 261. For example, the output lookup table 282 can cache the first output pixel value 261 in accordance with the content parameter 211 (e.g., a color index) that the output lookup table 282 receives in-time from the latency FIFO unit 244 via the LUT pipeline, as described above. In an aspect, the output lookup table 282 can determine an association of the first output pixel value 261, the index value 241, the content parameter 211, the first pixel 210, based on the spatial and temporal correlations enabled and described above in connection with all of the input lookup table 232, the output lookup table 282, the binning and compare unit 228, and the index generator 240, in addition to the aspects discussed above with respect to this LUT pipeline.

In other words, as illustrated, the latency FIFO unit 244 can send the LUT pipeline information to the output lookup table 282, in accordance with the input lookup table 232 and the FIFO replacement policy 283 (e.g., thus, syncing the FIFO replacement policy 283 and the input lookup table 232 via the LUT pipeline). In this way, when the first output pixel value 261 is received at the output lookup table 282, and the communications from the latency FIFO unit 244 are further received at the output lookup table 282, the temporal and spatial correlations described above cause the ISP bypass system 200 to modify the output lookup table 282 to include the first output pixel value 261 in association with the first output pixel value 261 (e.g., related to the content parameter 211) and then match the content parameter 213 to the content parameter 211 so as to set the second output pixel value 263 equal to the first output pixel value 261.

In contrast, in the hit case (e.g., for the second pixel 212), when the latency FIFO unit 244 sends the hit=1 information and the LUT pipeline (the index value 243 and the content parameter 213) to the output lookup table 282, the output lookup table 282 may again proceed according to the temporal and spatial correlations established by this LUT pipeline. That is, the output lookup table 282 can then access the set of cached pixel values 281 to locate the one of the set of cached pixel values 281 that matches with the content parameter 213 (e.g., the content parameter 211 in this example). In this way, the output lookup table 282 can effectively predict an output pixel value for the second pixel 212 (e.g., the second output pixel value 263) as being equal to the first output pixel value 261. Therefore, the output lookup table 282 can set the second output pixel value 263 as equal to the first output pixel value 261 in accordance with the FIFO replacement policy 283 and the LUT pipeline (e.g., the spatial and temporal correlations), as described above.

Moving to the output stage for the ISP bypass system 200, as described above, the ISP bypass system 200 will output the total number of output pixels 299 as equal to the total number of input pixels 201. To accomplish this, the ISP bypass system 200 will ensure that the output device (e.g., the third ISP block 120) receives both a valid value and data information for each of the total number of output pixels the total number of output pixels 299 and that the third ISP block 120 receives such values and information in the proper order and at the proper time (e.g., largely based on the latency FIFO unit 244 aspects described above).

As an example, the output lookup table 282 can be latched to the multiplexer 248. The multiplexer 248 can receive output pixel data, for each individual pixel of the total number of input pixels 201, from either the second ISP block 116 (e.g., via the first output pixel value 261) or from the output lookup table 282 (e.g., the second output pixel value 263). As illustrated, and based on the descriptions above, in the miss case (e.g., for the first pixel 210 in this example), the multiplexer 248 will receive the first output pixel value 261 from the second ISP block 116. As described above, at the same or similar time, the first output pixel value 261 will also be cached at the output lookup table 282. In contrast, in the hit case (e.g., for the second pixel 212 in this example), the multiplexer 248 will receive the second output pixel value 263 from the output lookup table 282. As described above, in this hit case, computations for the second pixel 212 will have been bypassed so as to allow for the output lookup table 282 to set the second output pixel value 263 to be equal to the first output pixel value 261 that was already stored at the output lookup table 282 during the miss case.

In an embodiment, the multiplexer 248 may comprise a 2×1 multiplexer, thus receiving two input values and outputting one value. Thus, for each pixel, the multiplexer 248 may receive both the second output pixel value 263 and the first output pixel value 261. However, because the multiplexer 248 is latched to the output lookup table 282 (e.g., via the content parameter 211, the content parameter 213, the index value 241, the index value 243, etc.), the multiplexer 248 may also be enabled to determine the hit or miss case for the pending pixel and determine which value to pass accordingly.

For example, in the hit case, the multiplexer 248 will pass the second output pixel value 263, and in the miss case, the multiplexer 248 will pass the first output pixel value 261. Furthermore, so as to pass the validity data for each of the pixels, the OR gate 227 may receive the valid_out from the latency FIFO unit 244 (e.g., in the hit case) or from the second ISP block 116 (e.g., in the miss case). For each pixel, the corresponding pixel valid data will be passed from the OR gate 227 to the third ISP block 120. In an aspect, the latency FIFO unit 244 may wait to receive an input ready signal from the third ISP block 120 (e.g., item C) before sending a valid_out to the OR gate 227. Having passed data for each pixel (e.g., one of the first output pixel value 261 or the second output pixel value 263 for each of the pixels, updated for each individual pixel), in addition to validity data for each pixel (e.g., one of the valid_out from the latency FIFO unit 244 or from the second ISP block 116, updated for each individual pixel), the total number of output pixels 299 will then include data and validity data, in-time, for all of the total number of input pixels 201.

In this way, the ISP bypass system 200 will have effectively processed and passed all of the total number of input pixels 201 (e.g., thus, without reducing resolution) without the need to actually process any of the redundant pixels (e.g., thus, without reducing quality). Thus, the ISP bypass system 200 will have reduced power consumption at, for example, the second ISP block 116 (and all subsequent ISPs, for example, the third ISP block 120), and therefore the imaging hardware system 100.

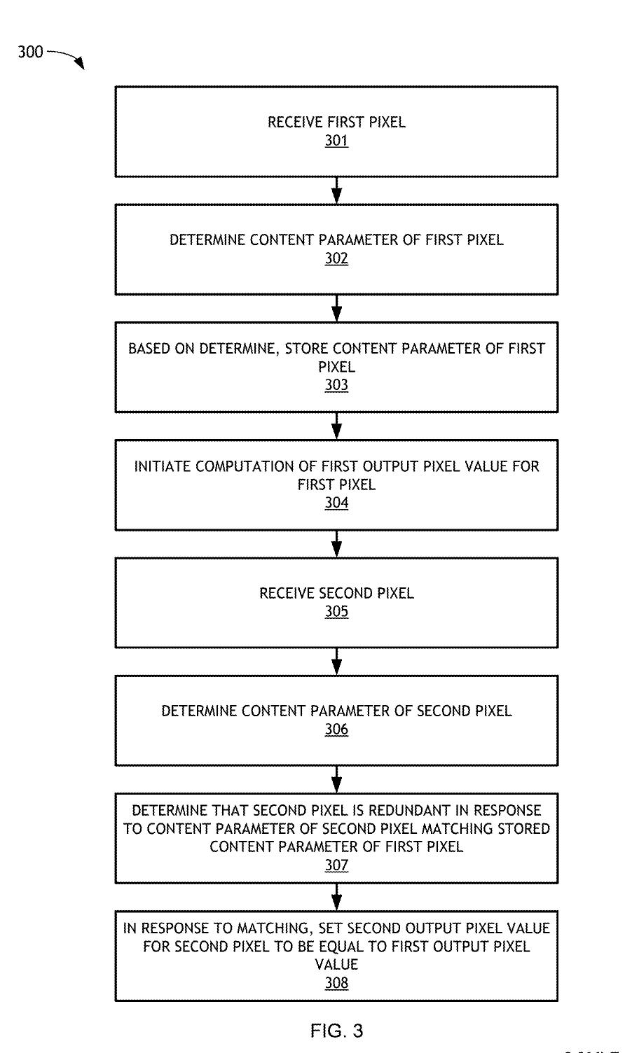

FIG. 3 is a flowchart of a method for processing pixels of an image at an imaging hardware device (e.g., the imaging hardware system 100). At a step 301 the method comprises receiving a first pixel. At a step 302, the method further comprises determining a content parameter of the first pixel. At a step 303, the method further comprises, based on the determining, storing the content parameter of the first pixel. At a step 304, the method further comprises initiating a computation of a first output pixel value for the first pixel. At a step 305, the method further comprises receiving a second pixel. At a step 306, the method further comprises determining a content parameter of the second pixel. At a step 307, the method further comprises determining that the second pixel is redundant in response to the content parameter of the second pixel matching the stored content parameter of the first pixel. At a step 308, the method further comprises, in response to the matching, setting a second output pixel value for the second pixel to be equal to the first output pixel value.

In one example, means for receiving a first pixel may comprise the ISP bypass system 102 and/or the ISP bypass system 200, for example, via the binning and compare unit 228. In one example, means for determining a content parameter of the first pixel may comprise the ISP bypass system 102 and/or the ISP bypass system 200, for example, via one or more of the binning and compare unit 228 and/or the input lookup table 232. In one example, means for storing a content parameter may comprise the ISP bypass system 102 and/or the ISP bypass system 200, for example, via one or more of the binning and compare unit the binning and compare unit 228 and/or the input lookup table 232 in connection with the set of stored content parameters 231 and/or the FIFO replacement policy 233. In one example, means for initiating a computation may comprise the ISP bypass system 102 and/or the ISP bypass system 200, for example, via one or more of the index generator 240 and/or the AND gate 226. In one example, means for receiving a second pixel may comprise the ISP bypass system 102 and/or the ISP bypass system 200, for example, via the binning and compare unit 228. In one example, means for determining a content parameter of the second pixel may comprise the ISP bypass system 102 and/or the ISP bypass system 200, for example, via one or more of the binning and compare unit 228 and/or the input lookup table 232. In one example, means for determining that the second pixel is redundant in response to the content parameter of the second pixel matching the stored content parameter of the first pixel may comprise the ISP bypass system 102 and/or the ISP bypass system 200, for example, via one or more of the binning and compare unit 228 and/or the input lookup table 232. In one example, means for matching the stored content parameter of the first pixel to the content parameter of the second pixel may comprise the ISP bypass system 102 and/or the ISP bypass system 200, for example, via one or more of the binning and compare unit 228 and/or the input lookup table 232. In one example, means for in response to the matching, setting a second output pixel value for the second pixel to be equal to the first output pixel value, may comprise the ISP bypass system 102 and/or the ISP bypass system 200, for example, via one or more components of the logic circuit described above in connection with FIG. 2, for example, the input lookup table 232, the binning and compare unit 228, the index generator 240, the latency FIFO unit 244, the output lookup table 282, the multiplexer 248, the OR gate 227, the AND gate 226, etc. In one example, means for bypassing a computation for a pixel, means for outputting a pixel value in association with a pixel, means for setting an output pixel value, means for caching, means for storing, means for waiting, means for receiving, etc. may comprise the ISP bypass system 102 and/or the ISP bypass system 200, for example, via one or more components of the logic circuit described above in connection with FIG. 2, for example, the input lookup table 232, the binning and compare unit 228, the index generator 240, the latency FIFO unit 244, the output lookup table 282, the multiplexer 248, the OR gate 227, the AND gate 226, etc.

In one non-limiting example, in connection with the ISP bypass system 200 as illustrated in FIG. 2, means for receiving a first pixel, wherein the means for receiving is further configured to determine a content parameter of the first pixel, may comprise the binning and compare unit 228. In one non-limiting example, in connection with the ISP bypass system 200 as illustrated in FIG. 2, means for storing, based on the determining, the content parameter of the first pixel, may comprise the input lookup table 232. In one non-limiting example, in connection with the ISP bypass system 200 as illustrated in FIG. 2, means for initiating a computation of a first output pixel value for the first pixel, may comprise the AND gate 226. In one non-limiting example, in connection with the ISP bypass system 200 as illustrated in FIG. 2, means for receiving a second pixel, determining a content parameter of the second pixel, and determine that the second pixel is redundant in response to the content parameter of the second pixel matching the stored content parameter of the first pixel, may comprise the binning and compare unit 228. In one non-limiting example, in connection with the ISP bypass system 200 as illustrated in FIG. 2, means for facilitating, in response to a matching, setting a second output pixel value for the second pixel to be equal to the first output pixel value, may comprise the logic circuit facilitating one or more of the multiplexer 248 and the output lookup table 282 to set. In one non-limiting example, in connection with the ISP bypass system 200 as illustrated in FIG. 2, means for facilitating bypassing a computation for the second pixel based on the determination that the second pixel is redundant, may comprise the logic circuit facilitating one or more of the latency FIFO 244, the multiplexer 248, and/or the OR gate 227 to bypass. In one non-limiting example, in connection with the ISP bypass system 200 as illustrated in FIG. 2, means for facilitating, based on a computation, outputting the first output pixel value in association with the first pixel, may comprise the logic circuit facilitating the multiplexer 248 to output. In one non-limiting example, in connection with the ISP bypass system 200 as illustrated in FIG. 2, means for caching and/or storing the first output pixel value in a cache, may comprise the output lookup table 282. In one non-limiting example, in connection with the ISP bypass system 200 as illustrated in FIG. 2, means for outputting, from the cache, the first output pixel value in association with the second pixel, so as to bypass a computation for the second pixel, may comprise the output lookup table 282. In one non-limiting example, in connection with the ISP bypass system 200 as illustrated in FIG. 2, means for waiting a number of clock cycles may comprise the latency FIFO 244.

As used herein, the term “determining” and/or “identifying” encompass a wide variety of actions. For example, “determining” and/or “identifying” may include calculating, computing, processing, deriving, choosing, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, identifying, establishing, selecting, choosing, determining and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) signal or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by the imaging hardware system 100, the ISP bypass system 102, the ISP bypass system 200, and/or another system or device, as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an imaging hardware system 100, an ISP bypass system 102, an ISP bypass system 200, and/or another device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for processing pixels of an image at an imaging hardware device, the method comprising:
receiving a first pixel;
determining a content parameter of the first pixel;
based on the determining, storing the content parameter of the first pixel;
initiating a computation of a first output pixel value for the first pixel;
receiving a second pixel;
determining a content parameter of the second pixel;
determining that the second pixel is redundant in response to the content parameter of the second pixel matching the stored content parameter of the first pixel; and
in response to the matching, setting a second output pixel value for the second pixel to be equal to the first output pixel value.

2. The method of claim 1, the method further comprising bypassing a computation for the second pixel based on the determination that the second pixel is redundant.

3. The method of claim 2, the method further comprising:
based on the computation, outputting the first output pixel value in association with the first pixel;
storing the first output pixel value in a cache; and
outputting, from the cache, the first output pixel value in association with the second pixel, so as to bypass the computation for the second pixel.

4. The method of claim 1, wherein storing the content parameter of the first pixel comprises inserting the content parameter of the first pixel into an input lookup table, wherein the content parameter of the first pixel is stored in response to determining that the content parameter of the first pixel does not match with any of a number of content parameters stored in the input lookup table, and wherein the computation of the first output pixel value is initiated in response to determining that the content parameter of the first pixel does not match with any of a number of content parameters stored in the input lookup table.

5. The method of claim 4, wherein determining the content parameter of the first and second pixels enables one or both of a spatial correlation and a temporal correlation, wherein the content parameter of the first pixel is inserted into the input lookup table in accordance with one or both of the spatial correlation and the temporal correlation, and wherein matching the content parameter of the second pixel to the stored content parameter of the first pixel is based on one or both of the spatial correlation and the temporal correlation, wherein the spatial correlation is based on a content category of the first and second pixels, and wherein the temporal correlation is based on a first-in-first-out replacement policy for the input lookup table.

6. The method of claim 1, the method further comprising:
based on the computation, caching the first output pixel value in an output lookup table in accordance with a temporal correlation, wherein the second output pixel value is set to be equal to the first output pixel value in accordance with one or both of the temporal correlation and a spatial correlation, wherein the spatial correlation is based on a content category of the first and second pixels, and wherein the temporal correlation is based on a first-in-first-out replacement policy for the output lookup table; and
syncing the first-in-first-out replacement policy for the output lookup table with a first-in-first-out replacement policy for the input lookup table.

7. The method of claim 1, the method further comprising:
based on the computation, storing the first output pixel value in a cache; and
waiting a number of clock cycles before setting the second output pixel value equal to the first output pixel value in the cache, wherein the number of clock cycles to wait is based on a latency operation.

8. The method of claim 1, the method further comprising:
receiving a total number of input pixels for the image, wherein the first and second pixels are included in the total number of input pixels for the image; and
outputting a total number of output pixels for the image, wherein the total number of output pixels for the image is equal to the total number of input pixels for the image.

9. An apparatus for processing pixels of an image, the apparatus comprising:
a binning and compare unit configured to:
receive a first pixel; and
determine a content parameter of the first pixel;
an input lookup table in connection with the binning and compare unit, wherein the input lookup table is configured to, based on the binning and compare unit determining the content parameter of the first pixel, store the content parameter of the first pixel;
an index generator configured to initiate, in connection with a first logic component, a computation of a first output pixel value for the first pixel,
wherein the binning and compare unit is further configured to:
receive a second pixel;
determine a content parameter of the second pixel; and
in connection with the input lookup table, determine that the second pixel is redundant in response to the content parameter of the second pixel matching the stored content parameter of the first pixel; and
a logic circuit for establishing a data connection between the input lookup table and an output lookup table, wherein in response to the matching, the logic circuit is configured to facilitate, at a selection module in connection with the output lookup table, setting a second output pixel value for the second pixel to be equal to the first output pixel value.

10. The apparatus of claim 9, wherein the logic circuit is further configured to facilitate, at a latency timing unit in connection with a second logic component and the output lookup table, bypassing a computation for the second pixel based on the determination that the second pixel is redundant.

11. The apparatus of claim 10, wherein the output lookup table is configured to store the first output pixel value in a cache, and wherein the selection module is configured to:
based on the computation of the first output pixel value, output the first output pixel value in association with the first pixel; and
output, from the cache, the first output pixel value in association with the second pixel, so as to bypass the computation for the second pixel.

12. The apparatus of claim 9, wherein the binning and compare unit is further configured to determine that the content parameter of the first pixel does not match with any of a number of content parameters stored in the input lookup table, wherein:
storing the content parameter of the first pixel comprises, in response to the determination that the content parameter of the first pixel does not match, inserting the content parameter of the first pixel into the input lookup table; and
the computation of the first output pixel value is initiated in response to the determination that the content parameter of the first pixel does not match.

13. The apparatus of claim 12, wherein determining the content parameter of the first and second pixels enables one or both of a spatial correlation and a temporal correlation, wherein the content parameter of the first pixel is inserted into the input lookup table in accordance with one or both of the spatial correlation and the temporal correlation, and wherein matching the content parameter of the second pixel to the stored content parameter of the first pixel is based on one or both of the spatial correlation and the temporal correlation, wherein the spatial correlation is based on a content category of the first and second pixels, and wherein the temporal correlation is based on a first-in-first-out replacement policy for the input lookup table.

14. The apparatus of claim 9, wherein the logic circuit is further configured to facilitate, at a latency timing unit in connection with the output lookup table:
caching the first output pixel value in accordance with a temporal correlation, wherein the second output pixel value is set to be equal to the first output pixel value in accordance with one or both of the temporal correlation and a spatial correlation, wherein the spatial correlation is based on a content category of the first and second pixels, and wherein the temporal correlation is based on a first-in-first-out replacement policy for the output lookup table; and
syncing the first-in-first-out replacement policy for the output lookup table with a first-in-first-out replacement policy for the input lookup table.

15. The apparatus of claim 9, wherein the logic circuit is further configured to facilitate, at a latency timing unit in connection with the output lookup table:
storing the first output pixel value in a cache; and
waiting a number of clock cycles before setting the second output pixel value equal to the first output pixel value in the cache, wherein the number of clock cycles to wait is based on a latency operation.

16. The apparatus of claim 9, wherein:
the binning and compare unit is further configured to receive a total number of input pixels for the image, wherein the first and second pixels are included in the total number of input pixels for the image; and
the selection module is further configured to output a total number of output pixels for the image, wherein the total number of output pixels for the image is equal to the total number of input pixels for the image.

17. An apparatus for processing pixels of an image, the apparatus comprising:
means for receiving a first pixel,
wherein the means for receiving is further configured to determine a content parameter of the first pixel;
means for storing, based on the determining, the content parameter of the first pixel;
means for initiating a computation of a first output pixel value for the first pixel,
wherein the means for receiving is further configured to:
receive a second pixel,
determine a content parameter of the second pixel, and
determine that the second pixel is redundant in response to the content parameter of the second pixel matching the stored content parameter of the first pixel; and
means for facilitating, in response to the matching, setting a second output pixel value for the second pixel to be equal to the first output pixel value.

18. The apparatus of claim 17, wherein the means for facilitating is further configured to facilitate bypassing a computation for the second pixel based on the determination that the second pixel is redundant.

19. The apparatus of claim 18, wherein the means for facilitating is further configured to facilitate:
based on the computation, outputting the first output pixel value in association with the first pixel;
storing the first output pixel value in a cache; and
outputting, from the cache, the first output pixel value in association with the second pixel, so as to bypass the computation for the second pixel.

20. The apparatus of claim 17, wherein storing the content parameter of the first pixel comprises inserting the content parameter of the first pixel into the means for storing, wherein the content parameter of the first pixel is stored in response to the determining that the content parameter of the first pixel does not match with any of a number of content parameters stored in the means for storing, and wherein the computation of the first output pixel value is initiated in response to determining that the content parameter of the first pixel does not match with any of a number of content parameters stored in the means for storing.

21. The apparatus of claim 20, wherein determining the content parameter of the first and second pixels enables one or both of a spatial correlation and a temporal correlation, wherein the content parameter of the first pixel is inserted into the means for storing in accordance with one or both of the spatial correlation and the temporal correlation, and wherein matching the content parameter of the second pixel to the stored content parameter of the first pixel is based on one or both of the spatial correlation and the temporal correlation, wherein the spatial correlation is based on a content category of the first and second pixels, and wherein the temporal correlation is based on a first-in-first-out replacement policy for the means for storing.

22. The apparatus of claim 17, the apparatus further comprising:
means for caching, based on the computation, the first output pixel value in a cache and in accordance with a temporal correlation, wherein the second output pixel value is set to be equal to the first output pixel value in accordance with one or both of the temporal correlation and a spatial correlation, wherein the spatial correlation is based on a content category of the first and second pixels, and wherein the temporal correlation is based on a first-in-first-out replacement policy for the means for caching, and
wherein the means for facilitating is further configured to facilitate syncing the first-in-first-out replacement policy for the means for caching with a first-in-first-out replacement policy for the means for storing.

23. The apparatus of claim 17, the apparatus further comprising:
means for caching, based on the computation, the first output pixel value in a cache, and
wherein the means for facilitating is further configured to facilitate waiting a number of clock cycles before setting the second output pixel value equal to the first output pixel value in the cache, wherein the number of clock cycles to wait is based on a latency operation.

24. The apparatus of claim 17, further comprising means for outputting, wherein:
the means for receiving is further configured to receive a total number of input pixels for the image, wherein the first and second pixels is included in the total number of input pixels for the image; and
the means for outputting is configured to output a total number of output pixels for the image, wherein the total number of output pixels for the image is equal to the total number of input pixels for the image.

25. A non-transitory computer-readable medium comprising code that, when executed, causes an apparatus to perform a method, the method comprising:
receiving a first pixel;
determining a content parameter of the first pixel;
based on the determining, storing the content parameter of the first pixel;
initiating a computation of a first output pixel value for the first pixel;
receiving a second pixel;
determining a content parameter of the second pixel;
determining that the second pixel is redundant in response to the content parameter of the second pixel matching the stored content parameter of the first pixel; and
in response to the matching, setting a second output pixel value for the second pixel to be equal to the first output pixel value.

26. The medium of claim 25, the method further comprising:
bypassing a computation for the second pixel based on the determination that the second pixel is redundant;
based on the computation, outputting the first output pixel value in association with the first pixel;
storing the first output pixel value in a cache; and
outputting, from the cache, the first output pixel value in association with the second pixel, so as to bypass the computation for the second pixel.

27. The medium of claim 25, wherein storing the content parameter of the first pixel comprises inserting the content parameter of the first pixel into an input lookup table, wherein the content parameter of the first pixel is stored in response to determining that the content parameter of the first pixel does not match with any of a number of content parameters stored in the input lookup table, and wherein the computation of the first output pixel value is initiated in response to determining that the content parameter of the first pixel does not match with any of a number of content parameters stored in the input lookup table, wherein determining the content parameter of the first and second pixels enables one or both of a spatial correlation and a temporal correlation, wherein the content parameter of the first pixel is inserted into the input lookup table in accordance with one or both of the spatial correlation and the temporal correlation, and wherein matching the content parameter of the second pixel to the stored content parameter of the first pixel is based on one or both of the spatial correlation and the temporal correlation, wherein the spatial correlation is based on a content category of the first and second pixels, and wherein the temporal correlation is based on a first-in-first-out replacement policy for the input lookup table.

28. The medium of claim 25, the method further comprising:
based on the computation, caching the first output pixel value in an output lookup table in accordance with a temporal correlation, wherein the second output pixel value is set to be equal to the first output pixel value in accordance with one or both of the temporal correlation and a spatial correlation, wherein the spatial correlation is based on a content category of the first and second pixels, and wherein the temporal correlation is based on a first-in-first-out replacement policy for the output lookup table; and
syncing the first-in-first-out replacement policy for the output lookup table with a first-in-first-out replacement policy for the input lookup table.

29. The medium of claim 25, the method further comprising:
based on the computation, storing the first output pixel value in a cache; and
waiting a number of clock cycles before setting the second output pixel value equal to the first output pixel value in the cache, wherein the number of clock cycles to wait is based on a latency operation.

30. The medium of claim 25, the method further comprising:
receiving a total number of input pixels for the image, wherein the first and second pixels is included in the total number of input pixels for the image; and
outputting a total number of output pixels for the image, wherein the total number of output pixels for the image is equal to the total number of input pixels for the image.
